(19) United States
(12) Patent Application Publication
(10) Pub. No.: US 2020/0336551 A1
(43) Pub. Date: Oct. 22, 2020

(54) CROSS-SITE SEMI-ANONYMOUS TRACKING

(71) Applicant: Facebook, Inc., Menlo Park, CA (US)

(72) Inventors: Andrew Knox, Brooklyn, NY (US); Tobias Henry Wooldridge, Seattle, WA (US)

(21) Appl. No.: 16/386,095

(22) Filed: Apr. 16, 2019

(51) Int. Cl. H04L 29/08; H04L 29/06; G06Q 30/02

(52) U.S. Cl. CPC H04L 67/146; H04L 63/0421; G06F 7/588; H04L 67/22; G06Q 30/0255

(57) ABSTRACT

Semi-anonymous tracking cookies may be utilized to provide relevant content and advertisements to users, while maintaining user privacy. A content publisher may place a tracking cookie on a device. The tracking cookie may include an attribute identifying the cookie as a cross-site semi-anonymous tracking cookie. The device may request anonymization advice for the tracking cookie. An anonymization service may provide anonymization advice for the tracking cookie. The device may store a semi-anonymous value based on the anonymization advice. The semi-anonymous value may be shared by multiple devices. The content publisher may store the actions performed by the multiple devices, without uniquely identifying which device performed the actions. Content and advertisements may be targeted to the device based on the stored actions performed by the multiple devices sharing the semi-anonymous value for the tracking cookie. Additionally, attribution for conversions may be calculated based on the stored actions.

### FIELD OF ART

The present invention generally relates to the field of computer technology, and more specifically, to tracking cookies.

### BACKGROUND

HTTP cookies (also referred to as a web cookie, Internet cookie, browser cookie, or simply cookie) are small pieces of data sent from a website and stored on the user's computer by the user's web browser while the user is browsing. Cookies allow websites to remember stateful information (such as items added in the shopping cart in an online store) or to record the user's browsing activity (including clicking buttons, logging in, or recording which pages were visited in the past).

Cookies may be used to store local configurations, to expedite login, or to distinguish users. Cookies used for local configuration may or may not be unique to the user, depending on the specific implementation. The cookies used for local configuration are not used cross-site. Cookies used for login purposes are unique to the user. The cookies used for login may be used cross-site if using a proxy login service.

Cookies may be used to track a user's online activity to provide relevant content to the user. However, many users and content publishers concerned with user privacy are hesitant to allow cookies to track an individual's online activity, especially when the tracking is performed by third parties. It is difficult for existing systems to provide targeted content to users while maintaining sufficient user privacy.

### SUMMARY

Semi-anonymous tracking cookies may be utilized to provide relevant content and advertisements to users, while maintaining user privacy. A content publisher may place a tracking cookie on a user device, such as on a browser of a user computer. The tracking cookie may include a cookie attribute identifying the cookie as a cross-site semi-anonymous tracking cookie. The user device may request anonymization advice for the tracking cookie. An anonymization service may provide anonymization advice for the tracking cookie. The user device may store a semi-anonymous value based on the anonymization advice. The same semi-anonymous value may be provided to and used by multiple user devices. The content publisher may store the actions performed by the multiple user devices, without uniquely identifying which user device performed the actions. Content and advertisements may be targeted to the user device based on the stored actions performed by the multiple user devices sharing the semi-anonymous value for the tracking cookie. Additionally, attribution for conversions may be calculated based on the stored actions.

Systems, articles of manufacture, and computer-implemented methods are described herein. The recited components may perform actions including: receiving, by a user device, a tracking cookie from a content publisher; detecting, by the user device, a semi-anonymous cookie attribute for the tracking cookie; in response to detecting the semi-anonymous cookie attribute, requesting, by the user device, anonymization advice for the tracking cookie from an anonymization service; receiving, by the user device, the anonymization advice for the tracking cookie from the anonymization service; storing, by the user device, a semi-anonymous value for the tracking cookie based on the anonymization advice; and transmitting, by the user device, the tracking cookie and the semi-anonymous value for the tracking cookie with a request for content.

In various embodiments, the actions may include replacing a unique value for the tracking cookie with the semi-anonymous value for the tracking cookie. The semi-anonymous value of the tracking cookie may be shared with a plurality of user devices. A content publisher may store a log file for actions performed by a plurality of user devices using the semi-anonymous value for the tracking cookie. The actions may comprise receiving content tailored based on the log file for actions performed by the plurality of user devices using the semi-anonymous value for the tracking cookie. The semi-anonymous value for the tracking cookie may be calculated by hashing a unique value for the user device, and truncating the resultant hash. The semi-anonymous value may be selected using a random number generator.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

FIG. 1 illustrates a computing environment in which semi-anonymous tracking cookies are used, according to one embodiment.

FIG. 2 illustrates the interactions that take place between different entities of FIG. 1 when utilizing a semi-anonymous tracking cookie, according to one embodiment.

FIG. 3 illustrates a screen shot for setting privacy levels of a semi-anonymous tracking cookie, according to one embodiment.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

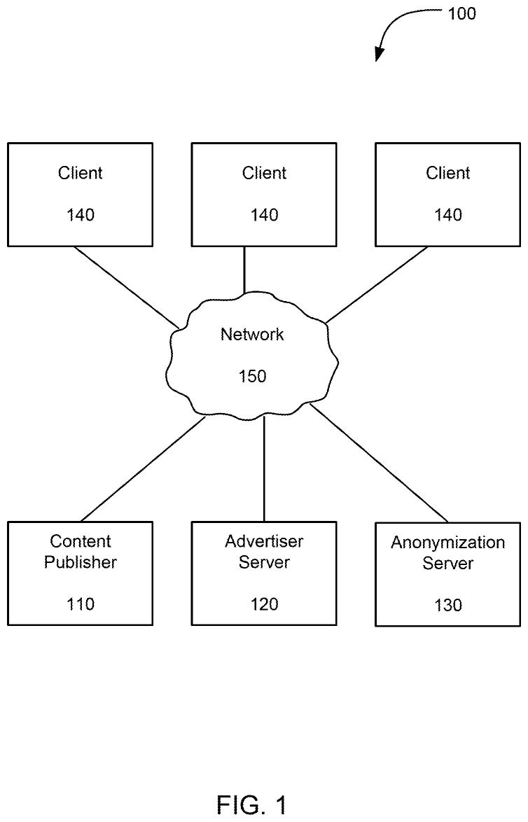

FIG. 1 illustrates a detailed view of a system 100 for utilizing semi-anonymous tracking cookies. The system may comprise a content publisher 110, an advertiser server 120, an anonymization server 130, and a plurality of client devices 140. These various components are now described in additional detail.

The content publisher 110 may comprise one or more computers, servers, and/or databases configured to generate digital content, such as a website or application, which may be accessed over a network. The content publisher 110 may be configured to transmit cookies to client devices.

The advertiser server 120 may comprise one or more computers, servers, and/or databases configured to generate digital content, such as a website or application, which may be accessed over a network. The advertiser server 120 may be operated by an advertiser that sells goods or services. The advertiser may advertise on third-party websites or applications, such as those provided by the content publisher 110.

The anonymization server 130 may comprise one or more computers, servers, and/or databases configured to provide anonymization advice and generate semi-anonymous tracking cookies. The anonymization server 130 may be configured to receive requests for anonymization advice from multiple user devices. The anonymization server may be configured to create groups of users based on user attributes. The anonymization server may be configured to generate a semi-anonymous tracking cookie for a user device. The anonymization server may be configured to provide semi-anonymous tracking cookies having the same value to multiple user devices in a group.

The client devices 140 are computing devices such as smart phones, laptop computers, desktop computers, or any other device that can communicate over a network. Users may utilize the client devices 140 to access content. For example, the client devices 140 may be used to access a social networking website or application provided by the content publisher 110 or to access a website or application provided by the advertiser server 120. The client devices 140 may each utilize a browser which stores cookies. The client devices 140 may each utilize an operating system and one or more applications.

The various system components may communicate over one or more networks 150. The network 150 may be any suitable communications network for data transmission. In an embodiment such as that illustrated in FIG. 1, the network 150 uses standard communications technologies and/or protocols and can include the Internet. In another embodiment, the entities use custom and/or dedicated data communications technologies.

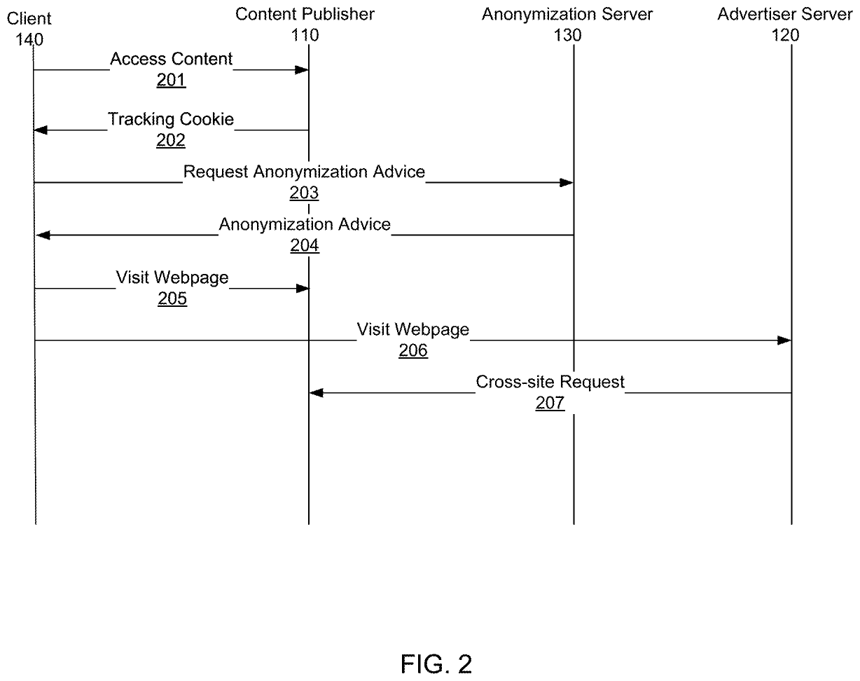

FIG. 2 illustrates the interactions that take place between different entities of FIG. 1 when tracking a user's actions using a semi-anonymous cookie according to one embodiment. A user may access content provided by the content publisher (step 201). For example, the user may visit a website provided by the content publisher using a browser on a user device, the user may open a mobile application provided by the content publisher, or the user may access a skill using a voice personal assistant. In one embodiment, the user device may transmit an HTTP request to the content publisher to access a webpage.

The content publisher may transmit a tracking cookie to the user device (step 202). In addition to the tracking cookie, the content publisher may transmit additional cookies, such as a login cookie and a configuration cookie. The tracking cookie may comprise one or more cookie attributes. The tracking cookie may comprise a semi-anonymous cookie attribute, which identifies the cookie as a semi-anonymous tracking cookie. For example, the tracking cookie may comprise the semi-anonymous cookie attribute “XSite” or “SemiAnon” which indicates that the tracking cookie should be anonymized. In general, cookie attributes are used by browsers to determine what actions to take with the cookie, such as when to delete the cookie, when to block the cookie, or whether to send the cookie to the server.

The semi-anonymous cookie attribute may indicate that the tracking cookie should be anonymized. In one embodiment, the semi-anonymous cookie attribute does not have an associated value. Rather, the presence of the attribute name “XSite” may indicate that its behavior should be enacted. However, in one embodiment the tracking cookie may at least initially include a unique value. For example, the content publisher may respond to an HTTP request with a response that includes the string “Set-Cookie: TRACK=123456789; Domain=contentpublisher.com; Expires=Fri, 9 Nov. 2040 11:00:00 GMT; XSite.” The string indicates that the cookie name and value are “TRACK” and “123456789” respectively. In one embodiment, the cookie may not include any field or value for the cookie name, as the “XSite” attribute may cause the browser to remove or replace any existing cookie name or value. The tracking cookie has the attribute “Domain” with the value “contentpublisher.com” instructing the browser to use the cookie when requesting pages from contentpublisher.com. The tracking cookie also has the attribute “Expires” with the value “Fri, 9 Nov. 2040 11:00:00 GMT” which indicates that the tracking cookie is a persistent cookie that will be stored by the browser until the specified date, or until the user manually deletes the cookie. The tracking cookie has the attribute “XSite” which will instruct the browser to anonymize the cookie.

In one embodiment, the tracking cookie may be a third-party cookie placed by the advertiser server via an advertisement on the website of the content publisher. In such case, the Domain attribute may have the value “advertiser.com”. Although some browsers and users do not permit third-party cookies, the browser or user may make an exception to allow third-party cookies which contain the semi-anonymous cookie attribute, because the tracking cookie will be semi-anonymized.

In one embodiment, the tracking cookie may not include a domain or path attribute. Thus, the tracking cookie may be transmitted to any website visited by the user device. Because the tracking cookie may be semi-anonymized, the browser and user may allow the cookie to be shared without privacy concerns.

The browser may request anonymization of the tracking cookie (step 203). The browser may detect the semi-anonymous cookie attribute, and in response to detecting the semi-anonymous cookie attribute the browser may request the anonymization of the tracking cookie. In one embodiment, the browser may transmit a request for anonymization advice from a trusted third-party anonymization service. However, in other embodiments, the anonymization service may be performed by the browser itself, or by the content publisher. In one embodiment, the browser may request a semi-anonymous cookie from the anonymization service at a user's request, regardless of whether any other party placed a tracking cookie on the user's browser.

In some embodiments, the anonymization service may generate a semi-anonymous cookie for the user device by a variety of different methods. Identical values for the semi-anonymous cookie may be shared with multiple users, such that entities may not be able to uniquely identify the user based on the semi-anonymous cookie. However, because the semi-anonymous cookie is limited to a small number of users, the actions taken by those sharing the semi-anonymous cookie will allow relevant content and advertisements to be targeted to those sharing the semi-anonymous cookie. With a relatively large number of users sharing the semi-anonymous cookie, the level of user privacy is high, but the relevancy of targeted content is low. In contrast, with a relatively low number of users sharing the semi-anonymous cookie, the level of user privacy is low, but the relevancy of targeted content is high.

In one embodiment, the anonymization service may anonymize the tracking cookie by providing a randomly generated number. For example, the anonymization service may receive one million requests for cookie anonymization in a day, and the anonymization service may use a random number generator to generate a random number between 1 and 100,000 for each request. Thus, on average ten users would share the same random number. If a higher level of privacy were desired, the anonymization service may generate fewer distinct random numbers, such as by generating a random number between 1 and 100 for each request. In such case, on average 10,000 users would share the same random number, but the ability of content publishers and advertisers to provide targeted content would be diminished.

In one embodiment, rather than providing a completely random number, the anonymization service may group similar users together and provide a shared tracking cookie for the group of similar users. The anonymization service may use a variety of available data to group the users together. For example, the anonymization service may group users based on age, gender, location, spending habits, internet patterns, etc. In one embodiment, the browser may transmit demographic information about the user to the anonymization service, such as the age, gender, etc., to allow the anonymization service to group the user with similar users. In one embodiment, the browser may prompt the user to select which information about the user to share with the anonymization service.

In one embodiment, the anonymization service may group users together by applying additional filters until a predetermined group size is achieved. For example, the anonymization service may determine that the group size should be less than 100 users, and the anonymization service may first apply a gender filter, then an age filter, then a location filter, etc., until the remaining number of users that meet the criteria is less than 100.

In one embodiment, the anonymization service may hash a unique value for the user, then truncate the hash value to provide anonymity. For example, the anonymization service may hash the user's userID for the content publisher, or the value of the semi-anonymous cookie name provided by the content publisher. The anonymization service may run a hashing algorithm on the semi-anonymous cookie name value 123456789, and the resultant hash value may be 1001110100010. The anonymization service may select a certain number of digits to keep, with the greater number being kept resulting in a lower level of privacy. For example, the anonymization service may keep the first six digits 100111 and delete the remaining digits. All users with the same first six digits 100111 will be grouped together with the same semi-anonymous cookie, which may be the six-digit value 100111, or an alternative value generated by the anonymization service. If the anonymization service wished to have a greater level of privacy, the anonymization service may keep fewer digits, such as only the first four digits 1001, and all users with the same four digits may be grouped together.

The anonymization service may transmit anonymization advice to the user device (step 204). In one embodiment, the anonymization service may instruct the user device to replace the unique cookie name provided by the content publisher with the semi-anonymous cookie name generated by the anonymization service. In one embodiment, the anonymization service may transmit a new tracking cookie to the user device which includes the semi-anonymous cookie name. The anonymization service may instruct the browser to delete the previously stored tracking cookie which uniquely identified the user's browser.

In some embodiments, the anonymization advice may comprise guidance to the user device regarding how the browser may generate a semi-anonymous value for the cookie with a desired level of anonymity. For example, the anonymization advice may comprise information regarding the number of users with semi-anonymous cookies provided by the content provider. The anonymization service may obtain such information by agreement with the content provider, via third-party data providers, or based on the number of requests for anonymization advice the anonymization service receives from users. The anonymization service may receive from the user device, or suggest to the user device, a desired level of anonymity. For example, the user device may indicate in the anonymization request that the user device desires to be grouped together with approximately 5,000 other users. The anonymization service may determine that the content provider has 5,000,000 users. The anonymization service may instruct the user to truncate the semi-anonymous value to the first or last ten bits (which would have 1024) combinations. With 5,000,000 users and 1024 combinations, the ten-bit semi-anonymous value would give the user the desired anonymity of approximately 1 in 5,000. The number of bits suggested by the anonymization service may vary based on the number of users and the desired level of anonymity. For example, if a content provider had only 5,000 users and the user's desired level of anonymity was 1 in 5,000, the anonymization service may instruct the user device to provide the semi-anonymous cookie without any value for the semi-anonymous cookie. The anonymization service may instruct the user device to anonymize the semi-anonymous value via a variety of methods as previously described herein with respect to the anonymization service.

The user may subsequently visit one or more webpages of the content publisher (step 205). With each request sent by the browser on the user device, the request will include the semi-anonymous cookie, as well as any other cookies set by the content publisher. The content publisher may store a log file of actions performed by users of the semi-anonymous cookie. Each time the user visits a webpage, the browser may transmit information including the URL of the requested webpage and the date/time of the request.

However, because multiple users have the same value for the semi-anonymous cookie, the content publisher may store the actions of multiple users in the same log file. Thus, the content publisher may have knowledge of the actions performed by the group of users having semi-anonymous cookies with the same value, but the content publisher may not have knowledge of the actions performed by any specific user.

The user may visit a webpage provided by the advertiser server (step 206). In one embodiment, the user may select an advertisement on the content publisher website and be directed to the advertiser server. In another embodiment, the user may have been presented with an advertisement on a webpage of the content publisher, but the user may visit the advertiser server webpage independently, such as by typing the URL <advertiser.com> into the browser. In one embodiment, the user may not have been previously presented with an advertisement from the advertiser server.

The advertiser server may initiate a cross-site request to the content publisher (step 207). The advertiser server may initiate the cross-site request via a redirect in the browser. The advertiser server webpage may redirect the browser to one or more different websites for tracking, including to a webpage of the content publisher. The cross-site request may include information such as the semi-anonymous value for the cookie, the destination URL, and the referring URL, which will indicate to the content publisher that the request came from the advertiser server. In one embodiment, the browser may indicate to the advertiser server that the browser contains a semi-anonymous tracking cookie, such as by transmitting the semi-anonymous tracking cookie to the advertiser server. However, if the semi-anonymous tracking cookie was placed by the content publisher, the advertiser server may not have any data stored for the semi-anonymous tracking cookie. The cross-site request may include a request for the data stored by the content publisher in the log file for the tracking cookie.

In one embodiment, the content publisher may transmit all or a portion of the data in the log file to the advertiser server. The data may be transmitted via the browser or via an API. The advertiser server may utilize the data to select relevant content and/or advertisements to provide to the user. Additionally, the advertiser server may utilize the data to determine when and where any users of the semi-anonymous tracking cookie had viewed any advertisements for the advertiser. The advertiser server may use such information in calculating attribution models to determine how effective its advertisements had been.

In one embodiment, in response to the user visiting a webpage of the advertiser server, the cross-site cookie in the user's browser causes the browser to transmit the cross-site cookie value, the URL of the webpage, and the time of visit to the content publisher. The content publisher may store the information in the tracking log file. Additionally, the content publisher may determine whether any user of the semi-anonymous tracking cookie had previously viewed an advertisement for the advertiser on a webpage provided by the content publisher. The content publisher may store such an event as a conversion, which may affect the compensation received from the advertiser server for any advertisements placed on webpages provided by the content publisher.

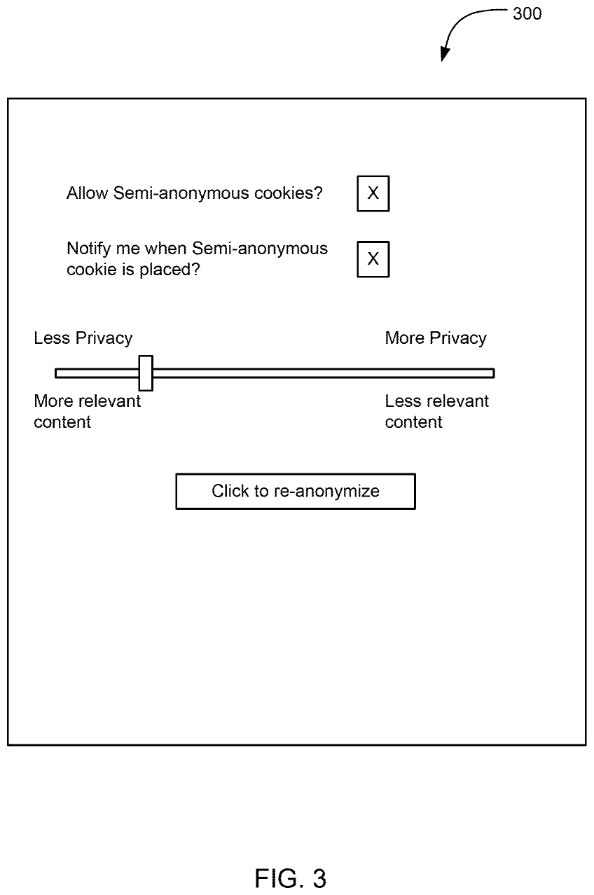

Referring to FIG. 3, a screenshot 300 of a window allowing a user to set semi-anonymous tracking cookie permission levels is illustrated. In one embodiment, the window may pop-up in response to the content publisher or any other website attempting to place a semi-anonymous tracking cookie on the user's browser or device. In one embodiment, the user may access the permission levels through a settings menu in the browser or operating system.

The window may prompt the user to select whether to allow semi-anonymous tracking cookies to be placed on the browser. The window may prompt the user to select whether to be notified each time a semi-anonymous cookie is placed on the browser. The window may provide a sliding bar or other indicator to allow the user to select a desired level of privacy for semi-anonymous cookies. As illustrated, the left end of the sliding bar represents a low level of privacy, where the semi-anonymous cookie may be identical to the semi-anonymous cookies for a relatively smaller number of other users, such as ten users, but the user may receive relatively greater relevance in content and advertisements provided to the user. As illustrated, the right end of the sliding bar represents a high level of privacy, where the semi-anonymous cookie may be identical to the semi-anonymous cookies for a relatively larger number of other users, such as one million users, but the user may receive relatively lesser relevance in content and advertisements provided to the user. The sliding bar may comprise any suitable number of positions between the left end and the right end which allow the user to select a desired level of privacy and relevance.

In one embodiment, the window may provide the user with the option to re-anonymize existing semi-anonymous cookies on the user's browser. The user may feel like the user is being provided with content and advertisements which are not relevant to the user. For example, other users sharing the same value for the semi-anonymous tracking cookie may be viewing pages related to basket-weaving, for which the user is not interested in receiving related content. The user may select to receive a new semi-anonymous tracking cookie which is shared with a different group of users.

It is appreciated that although the figures and description illustrate and describe interactions according to several embodiments, the precise interactions and/or order of interactions may vary in different embodiments.

The various system components described herein may include at least one processor coupled to a chipset. Also coupled to the chipset are a memory, a storage device, a graphics adapter, and a network adapter. A display is coupled to the graphics adapter. In one embodiment, the functionality of the chipset is provided by a memory controller hub and an I/O controller hub. In another embodiment, the memory is coupled directly to the processor instead of the chipset.

The storage device is any non-transitory computer-readable storage medium, such as a hard drive, compact disk read-only memory (CD-ROM), DVD, or a solid-state memory device. The memory holds instructions and data used by the processor. The graphics adapter displays images and other information on the display. The network adapter couples the computer to a local or wide area network.

As is known in the art, a computer can have different and/or other components than those explicitly described herein. In addition, the computer can lack certain illustrated components. In one embodiment, a computer acting as a server may lack a graphics adapter, and/or display, as well as a keyboard or pointing device. Moreover, the storage device can be local and/or remote from the computer (such as embodied within a storage area network (SAN)).

As is known in the art, the computer is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device, loaded into the memory, and executed by the processor.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

### Other Considerations

The present invention has been described in particular detail with respect to various possible embodiments. Those of skill in the art will appreciate that the invention may be practiced in other embodiments. First, the particular naming of the components and variables, capitalization of terms, the attributes, data structures, or any other programming or structural aspect is not mandatory or significant, and the mechanisms that implement the invention or its features may have different names, formats, or protocols. Also, the particular division of functionality between the various system components described herein is merely for purposes of example, and is not mandatory; functions performed by a single system component may instead be performed by multiple components, and functions performed by multiple components may instead performed by a single component.

Some portions of above the description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of computer-readable storage medium suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A computer-implemented method comprising:
receiving, by a user device, a tracking cookie from a content publisher;
detecting, by the user device, a semi-anonymous cookie attribute for the tracking cookie;
in response to detecting the semi-anonymous cookie attribute, requesting, by the user device, anonymization advice for the tracking cookie from an anonymization service;
receiving, by the user device, the anonymization advice for the tracking cookie from the anonymization service;
storing, by the user device, a semi-anonymous value for the tracking cookie based on the anonymization advice; and
transmitting, by the user device, the tracking cookie and the semi-anonymous value for the tracking cookie with a request for content.

2. The computer-implemented method of claim 1, further comprising replacing a unique value for the tracking cookie with the semi-anonymous value for the tracking cookie.

3. The computer-implemented method of claim 1, wherein the semi-anonymous value of the tracking cookie is shared with a plurality of user devices.

4. The computer-implemented method of claim 1, wherein a content publisher stores a log file for actions performed by a plurality of user devices using the semi-anonymous value for the tracking cookie.

5. The computer-implemented method of claim 4, further comprising receiving content tailored based on the log file for actions performed by the plurality of user devices using the semi-anonymous value for the tracking cookie.

6. The computer-implemented method of claim 1, wherein the semi-anonymous value for the tracking cookie is calculated by hashing a unique value for the user device, and truncating the resultant hash.

7. The computer-implemented method of claim 1, wherein the semi-anonymous value is selected using a random number generator.

8. A non-transitory computer-readable storage medium comprising instructions executable by a processor, the instructions when executed causing the processor to perform actions comprising:
receiving, by the processor, a tracking cookie from a content publisher;
detecting, by the processor, a semi-anonymous cookie attribute for the tracking cookie;
in response to detecting the semi-anonymous cookie attribute, requesting, by the processor, anonymization advice for the tracking cookie from an anonymization service;
receiving, by the processor, the anonymization advice for the tracking cookie from the anonymization service;
storing, by the processor, a semi-anonymous value for the tracking cookie based on the anonymization advice; and
transmitting, by the processor, the tracking cookie and the semi-anonymous value for the tracking cookie with a request for content.

9. The non-transitory computer-readable storage medium of claim 8, the actions further comprising replacing a unique value for the tracking cookie with the semi-anonymous value for the tracking cookie.

10. The non-transitory computer-readable storage medium of claim 8, wherein the semi-anonymous value of the tracking cookie is shared with a plurality of user devices.

11. The computer-implemented method of claim 8, wherein a content publisher stores a log file for actions performed by a plurality of user devices using the semi-anonymous value for the tracking cookie.

12. The non-transitory computer-readable storage medium of claim 11, the actions further comprising receiving content tailored based on the log file for actions performed by the plurality of user devices using the semi-anonymous value for the tracking cookie.

13. The non-transitory computer-readable storage medium of claim 8, wherein the semi-anonymous value for the tracking cookie is calculated by hashing a unique value for the user device, and truncating the resultant hash.

14. The non-transitory computer-readable storage medium of claim 8, wherein the semi-anonymous value is selected using a random number generator.

15. A computer system comprising:
a computer processor; and
a non-transitory computer-readable storage medium comprising instructions that when executed by the computer processor cause the computer system to perform actions comprising:
receiving, by the computer processor, a tracking cookie from a content publisher;
detecting, by the computer processor, a semi-anonymous cookie attribute for the tracking cookie;
in response to detecting the semi-anonymous cookie attribute, requesting, by the computer processor, anonymization advice for the tracking cookie from an anonymization service;
receiving, by the computer processor, the anonymization advice for the tracking cookie from the anonymization service;
storing, by the computer processor, a semi-anonymous value for the tracking cookie based on the anonymization advice; and
transmitting, by the computer processor, the tracking cookie and the semi-anonymous value for the tracking cookie with a request for content.

16. The computer system of claim 15, the actions further comprising replacing a unique value for the tracking cookie with the semi-anonymous value for the tracking cookie.

17. The computer system of claim 15, wherein the semi-anonymous value of the tracking cookie is shared with a plurality of user devices.

18. The computer system of claim 15, wherein a content publisher stores a log file for actions performed by a plurality of user devices using the semi-anonymous value for the tracking cookie.

19. The computer system of claim 18, the actions further comprising receiving content tailored based on the log file for actions performed by the plurality of user devices using the semi-anonymous value for the tracking cookie.

20. The computer system of claim 15, wherein the semi-anonymous value for the tracking cookie is calculated by hashing a unique value for the user device, and truncating the resultant hash.
